(19) United States
(12) Patent Application Publication
(10) Pub. No.: US 2022/0017166 A1
(43) Pub. Date: Jan. 20, 2022

(54) CONVEY MODULAR VEHICLE SYSTEM AND METHOD OF COUPLING

(71) Applicant: Christian A. DELISE, Laguna Hills, CA (US)

(72) Inventor: Christian A. DELISE, Laguna Hills, CA (US)

(21) Appl. No.: 16/143,790

(22) Filed: Sep. 27, 2018

Related U.S. Application Data
(60) Provisional application No. 62/563,944, filed on Sep. 27, 2017.

(51) Int. Cl. B62D 63/02; B60L 53/80; B60K 1/04

(52) U.S. Cl. CPC B62D 63/025; B60K 2001/0455; B60K 1/04; B60L 53/80

(57) ABSTRACT

The present invention relates to a modular vehicle system and assembly thereof comprising a preassembled Body (Cabin Module) and a preassembled Chassis (Drive Module). More particularly, the present invention relates to the modular vehicle system allowing for the docking of a Cabin Module onto a Drive Module, and wherein Drive Modules can be seamlessly interchanged during the lifespan of the Cabin Module.

### CROSS-REFERENCE TO RELATED APPLICATIONS

This application claims benefit of U.S. Provisional Patent Application Ser. No. 62/563,944, filed 27 Sep. 2017, which is hereby incorporated herein by reference.

Priority of U.S. Provisional Patent Application Ser. No. 62/563,944, filed 27 Sep. 2017, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

### 1. Field of the Invention

The present invention relates to a modular vehicle system and assembly thereof comprising a preassembled Body (Cabin Module) and a preassembled Chassis (Drive Module). More particularly, the present invention relates to a modular vehicle system allowing for the capability of seamlessly interchanging drive modules during the lifespan of the Cabin Module.

### 2. General Background of the Invention

There is a general consensus in both the technology and automotive worlds that there is an increasing demand for new solutions to the rapid change coming. Contributing to this demand are changes in energy requirements and production demands to meet growth in varying markets. This is causing a parallel rise in automation, 3-D printing, and change in service models. It is in the best interest of these combined industries to streamline, by any means, the speed with which they can adapt to these new technologies.

Currently the energy sector is pointing towards electrification and battery usage to solve many of these issues. It is accurate that battery efficiency increasing is good for the industry, however, it is not the sole solution. Battery production will create as many issues as it solves while at the same time, increasing efficiency of the internal combustion engine and other competitive sources of energy mobile will still make for a tough transition to full electric use. Coupling that shift with an increased turnover rate resulting from a sharper obsolescence curve, the auto industry is poised to take the route of the cell phone industry. This would be very detrimental to the overall reduction of consumption given the scale and size of the automotive industry. If the goal of the industry is to decrease its environmental impact while maintaining a healthy sales curve, then alternative forms of adaptation and use must be considered. It is our intention to provide a modular solution to enhance the efficiency of the vehicle product life cycle, while allowing for an increased ability to more easily change fuel sources of an entire vehicle fleet at scale.

The following US patents and US patent application Publications are hereby incorporated herein by reference: U.S. Pat. Nos. 6,059,058; 4,842,326; and 2005/0049944.

International publication no. WO 2015108676 A1 is also hereby incorporated herein by reference.

### BRIEF SUMMARY OF THE INVENTION

The present invention relates to a modular vehicle system and assembly thereof comprising a preassembled Body (Cabin Module) and a preassembled Chassis (Drive Module). More particularly, the present invention relates to the modular vehicle system allowing for the docking of a Cabin Module onto a Drive Module, and wherein Drive Modules can be seamlessly interchanged during the lifespan of the Cabin Module.

The function of the modular vehicle system of the present invention is to allow for the capability of seamlessly interchanging drive modules during the lifespan of the Cabin Module. The Drive Module is a unique chassis platform which preferably has the ability to support an endless variation of powertrains: Internal Combustion, Electric, Hydrogen, Hybrids, Autonomous, and Experimental. The Drive Module is fully self-sufficient and can be operated and driven independent of the Cabin Module when decoupled. The Drive Module connects to the Body Module via a series of coupling locks, and can be attached and detached while in the Docking Bay. The Drive Module is controlled via a core set of wires contained in a single umbilical unit. The Umbilical houses power chords and fiber optics which manages all interfaces of the vehicle systems from the cockpit of the body module. When connected, the Drive Module and Cabin Module operate as a single vehicle. When the vehicle is in need of service or an upgraded drivetrain, the vehicle pulls in to docking bay and an automated system performs the swapping procedure in under one minute. The network of Drive Modules is designed to be updatable as emerging technologies improve—and thus drastically enhances the adaptability and efficiency of a single vehicle. The Drive Module system also allows for implementation of an original market strategy in the automotive industry which decreases depreciation values and increases vehicle life cycle longevity.

The present invention includes a modular vehicle system comprising a preassembled body, comprised of a Primary System Network and a Secondary System Network that can operate independently of each other, wherein the Primary System Network manages the driving interface, main controls, and power supply of the vehicle, and wherein the Secondary System Network, a preassembled chassis that connects to and can mate with the preassembled body via locking hardware; and a simplified network that allows for communication between and integration of the preassembled body and the pre-assembled chassis to form and operate as a single vehicle.

Preferably, the Primary System Network can be comprised of and is the power management for Info and Media, Heating Venting and Cooling, Auxiliary, Amenities, and Safety of the vehicle.

Preferably, the Primary System Network can be channeled through a Secured Primary Drive CAN bus (Controller Area Network message unit).

Preferably, the Secondary System Network can have at least one battery for backup for power.

Preferably, the CAN bus can connect to the preassembled chassis via a main umbilical connector port.

Preferably, the power supply of the preassembled body can connect to the preassembled chassis via a power connector port.

Preferably, the preassembled chassis can be one of the following:
a) hybrid gas/electric;
b) full electric; or
c) hydrogen fuel cell.

Preferably, the hybrid gas/electric preassembled chassis can be comprised of at least one battery cell, a gasoline tank, and a combustion motor/transmission.

Preferably, the full electric preassembled chassis can be comprised of at least one battery cell, at least one electric converter, and at least one electric motor.

Preferably, the hydrogen fuel cell preassembled chassis is comprised of at least one hydrogen tank, at least one fuel cell, and at least one electric motor.

The present invention includes a method of assembly of a modular vehicle system comprising providing a modulator rig, comprised of wheel supports, support discs, and a drill system, placing a preassembled body atop the modulator on the support discs, introducing a preassembled chassis within the perimeter of the modulator rig and placing the wheels of the chassis within the wheel supports, aligning the chassis with the preassembled body, and raising the chassis via the wheel supports up to the body, lifting the body off the support discs, connecting the chassis to the body via a drill system, securing the chassis to the body, and connecting a communication network between the body and the chassis so that they can operate as a singular vehicle.

Preferably, the drill system can be a pneumatic drill system.

Preferably, the wheel supports can be hydraulic.

The present invention includes a method of uncoupling a modular vehicle system comprising providing a modulator rig, comprised of wheel supports, support discs, and a drill system, placing a preassembled body, connected to a preassembled chassis via assembly hardware and connecting ports, atop the modulator rig, using the drill system to unscrew the assembly hardware, decoupling the connecting ports, lowering the chassis from the body via the wheel supports while allowing the body to remain on the support discs, connecting the chassis to a control device, and removing the chassis off the modulator rig.

Preferably, the wheel supports can be hydraulic.

Preferably, the drill system can be a pneumatic drill system.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a side view of a preferred embodiment of the present invention unassembled;

FIG. 2 is a side view of an unassembled preferred embodiment of the present invention;

FIG. 3 is a perspective view of an assembled preferred embodiment of the present invention;

FIGS. 4 and 5 are exploded perspective views of an unassembled preferred embodiment of the present invention;

FIG. 6 are perspective views of various alternate embodiments/drive train systems of the drive module of the present invention;

FIG. 7 shows top views and side views of the various embodiments of the drive module;

FIG. 8 is a preferred embodiment of the modulator and the cabin module of the present invention;

FIG. 9 is a top, side and front views of a preferred embodiment of the modulator of the present invention;

FIG. 10 is a top, side and front views of a preferred embodiment of the present invention showing the modulator and the cabin module in position;

FIGS. 11-14 are side views of a preferred embodiment of the present invention showing the process of separating the drive module from the cabin module on a modulator rig;

FIGS. 15-18 are side views of a preferred embodiment of the present invention showing the re-installation of a separate drive module to a cabin module on a modulator rig;

FIGS. 19-21 are perspective views of a preferred embodiment of the present invention showing the module swap process;

FIGS. 22-30 are various preferred embodiments of the present invention.

### DETAILED DESCRIPTION OF THE INVENTION

A more open-minded approach to future technologies and energy sources will allow for healthy competition which will drive more aggressive and effective progress. As the demand for more advanced vehicles increases, the transition to alternative energy sources and increased autonomy will benefit from a cumulative adoption method, where older models can be easily updated, rather than replaced outright. The life cycle of vehicles in use can be lengthened, and the industry as a whole can be better equipped to respond to changes.

In one embodiment, the present invention allows for continuous updating and adaptation of a vehicle's drive train for the entirety of its lifecycle. The present invention will drastically increase the adaption rate and improve the entire structure of vehicle ownership and use. When implemented as a wide scale infrastructure, the present invention's modular vehicle systems create a more sustainable energy use curve, while maintaining consistent movement and demand within the industry. Every new vehicle generation can take advantage of subsequent improvements in technology that will happen after their production. These techniques are currently applied in various ways to enhance manufacturing efficiencies for the automakers and parts suppliers. However, the modularity capabilities are severely limited for the consumer market. With the emergence of industrial 3D printing and improvement of system module interfaces, the technology is now available to produce easily swappable and adaptable technologies in and out of a variety of vehicles in a quick and efficient manner. The present invention creates a standardized vehicle and drivetrain relationship which enhances efficiency for both the manufacturer and the end user. Production will shift to focus in two segments—Drive Modules and Cabin Modules. New ownership models will be structured to increase value retention of the Cabin Module as the user's investment, while Drive Modules can be leased at lower financial risk and with the ability to be cycled in and out use for repair or modifications. As Drive Modules age and approach the end of their life cycle, they can be retrofitted with newer drivetrain and autonomous technology and be re-introduced at the top of the cycle. An additional benefit for the consumer market is the ability to shift between different drivetrains with varying performance capabilities, depending on the location or use. Swapping Drive Modules can be done in varying frequencies, and data collected from trending demand can assist manufacturers in more easily shifting to meet the market. Other operational benefits for the manufacturer include facilitating massive recalls and flexible service intervals. The manufacturing network will grow more independent in each region, and emerging markets will be much easier to manage. Development costs needed for new models will decrease as prototypes can cycle through various Drive Modules and Cabin Modules independent of the others' progress.

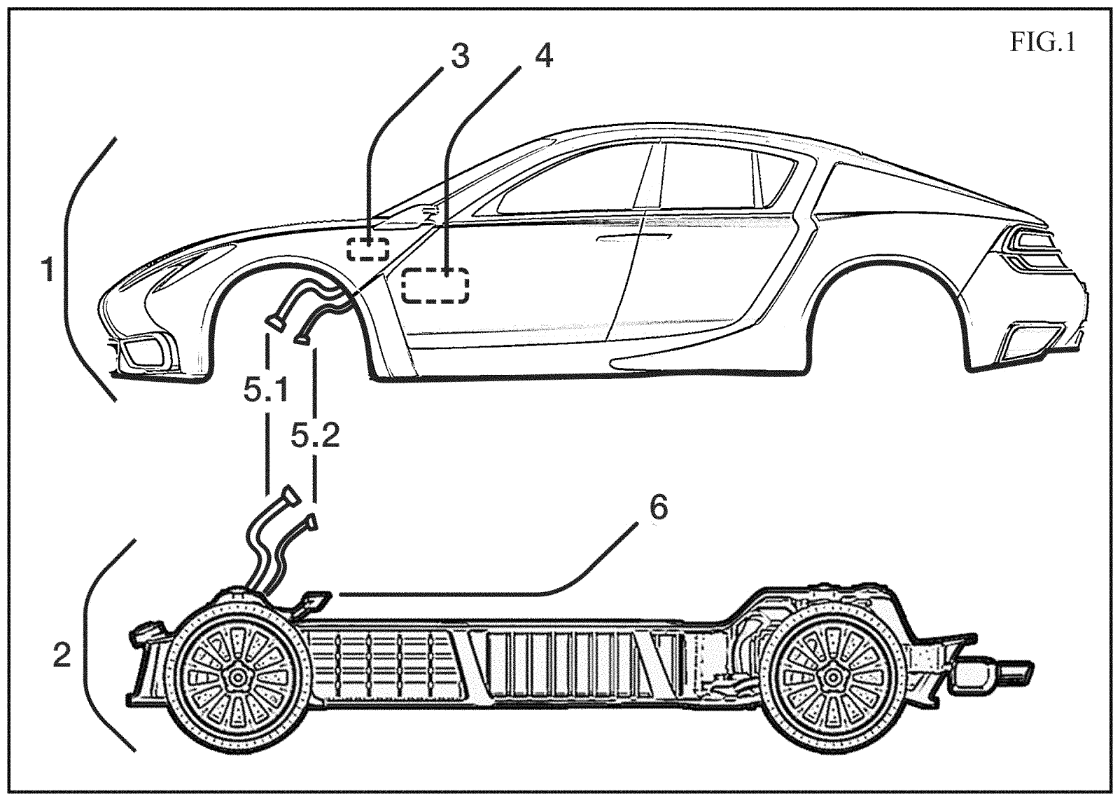

The present invention can be comprised of two main components: a preassembled body or Cabin Module 1 and a preassembled Chassis or Drive Module 2, as shown in FIGS. 1, 2, 4, and 5.

The Cabin Module 1 is preferably made of carbon composites. The Drive Module 2 is preferably made of high strength lightweight aluminum alloy.

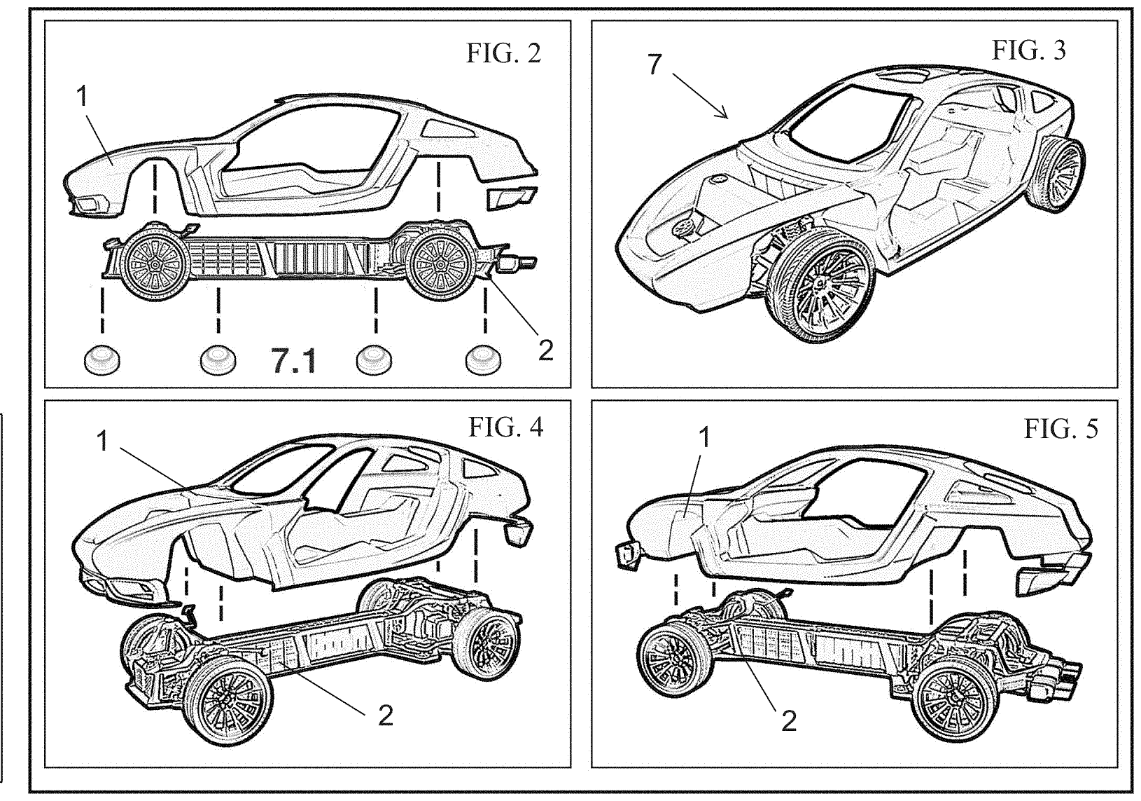

The design functionality of both modules relies on the utilization of a simplified vehicle communication network. In a preferred embodiment of the present invention, the Vehicle Cabin Module 1 is preferably comprised of two separate and independent systems. The Primary System Network (PSN) preferably manages the driving interface, main controls, and power supply. This system preferably is channeled through a Secured Primary Drive CAN Bus (Controller Area Network message unit) 3. As shown in FIG. 1, this CAN Bus preferably connects to the Drive Module 2 via a main Umbilical Connector Port 5.1. The Power Supply Convertor 4 preferably manages the power supply to the Cabin Module 1 and is preferably linked to the Drive Module 2 via the Power Connector Port 5.2. In a preferred embodiment of the present invention, once connected, the Drive Module 2 and the Cabin Module 1 operate as one to form a Joined Cabin Module Monocoque and Drive Module Chassis 7 as seen in FIG. 3. The Cabin Module 1 and Drive Module 2 preferably connect to each other via the locking hardware 7.1, as seen in FIG. 2. This hardware is preferably rated to sustain flex and stress of securely coupling the two modules as if they were unibody construction. In a preferred embodiment of the present invention, both the Drive Module 2 and Cabin Module 1 can be operated independently for convenience when separated.

In a preferred embodiment of the present invention, the internal operations of the vehicle are managed by a Secondary System Network (SSN) which is comprised of Info and Media, Heating, Venting and Cooling, Auxiliary, Amenities, Safety, and the power management for these systems. The SSN preferably operates independently of the PSN, preferably with a separate battery for backup, yet preferably still relies on core power from the Drive Module 2 connection. The PSN preferably operates independently of the SSN, maintaining navigating, sensing, and drive capabilities which can be controlled remotely.

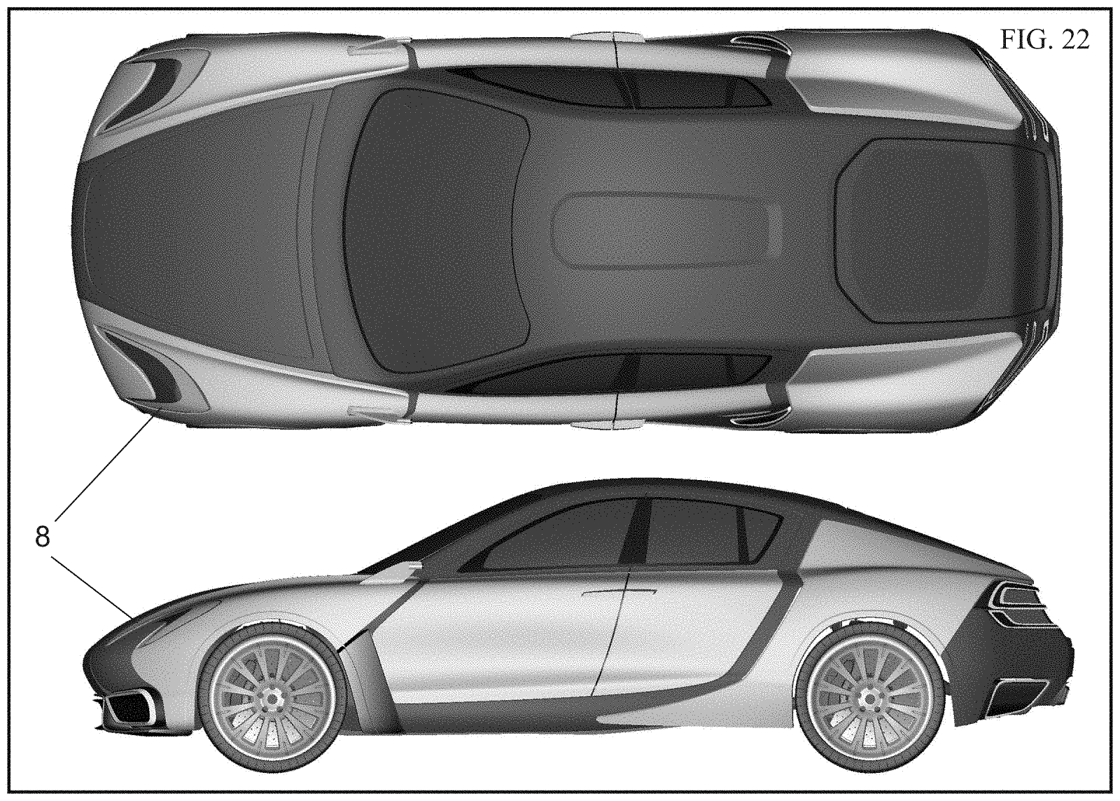

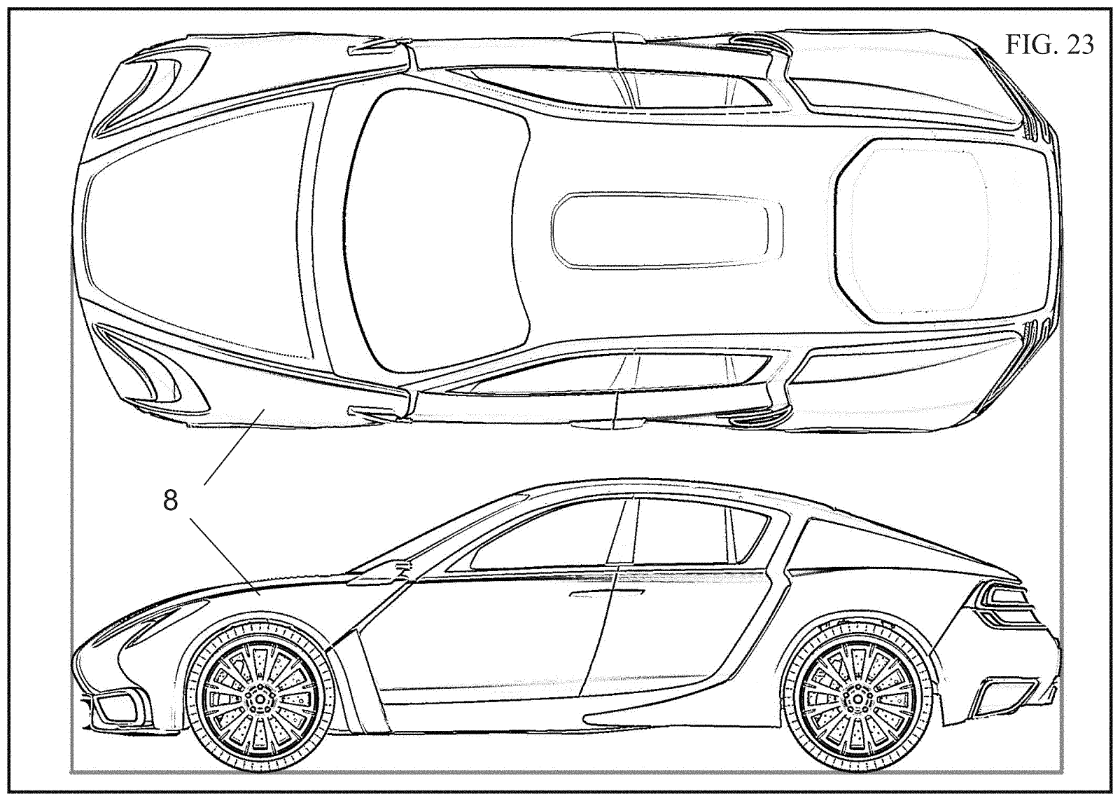

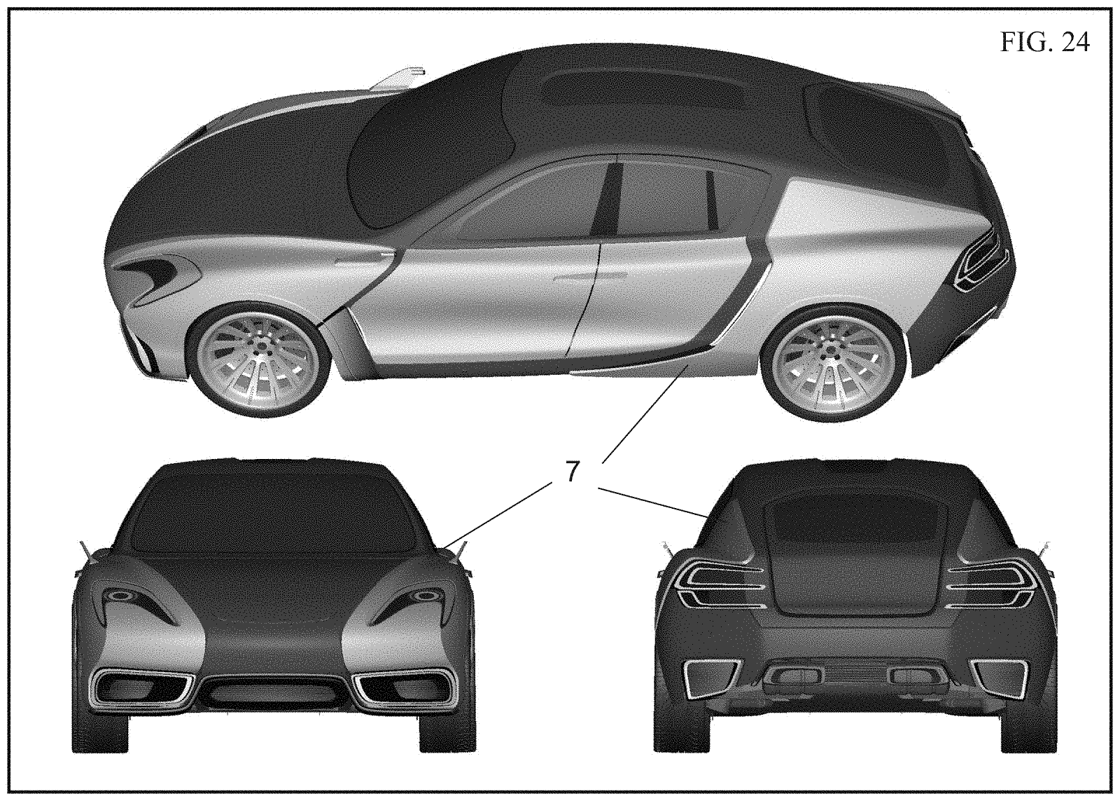

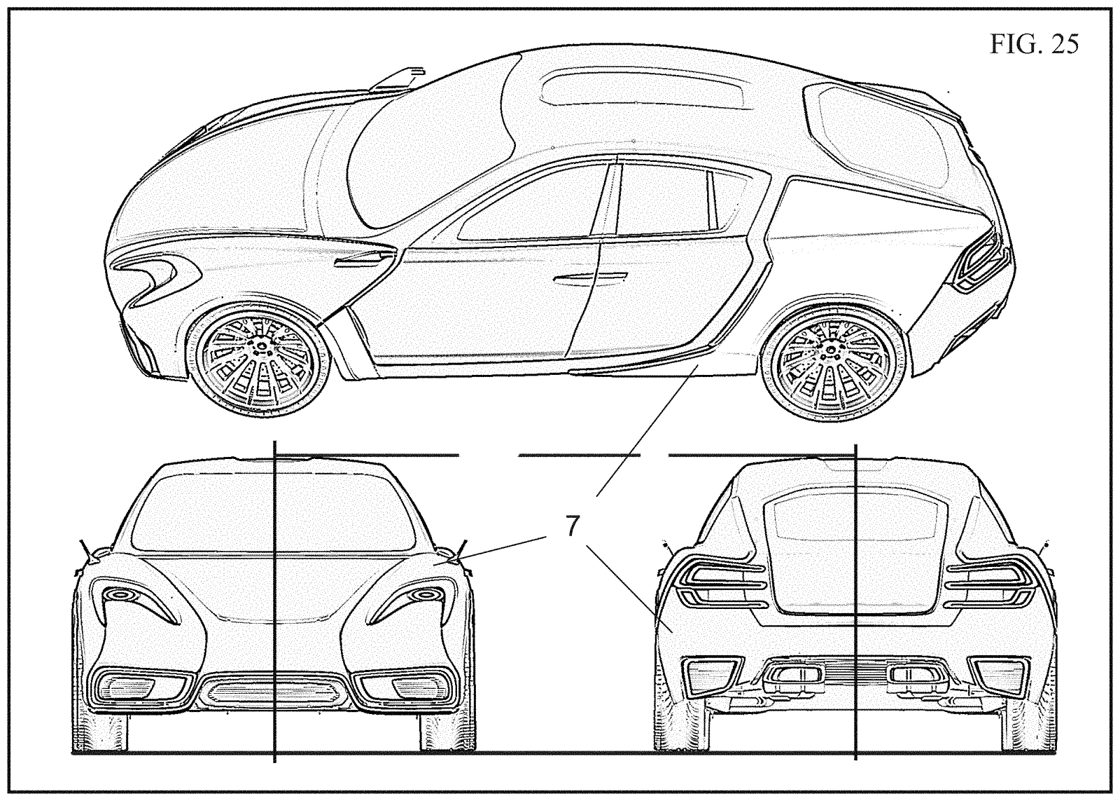

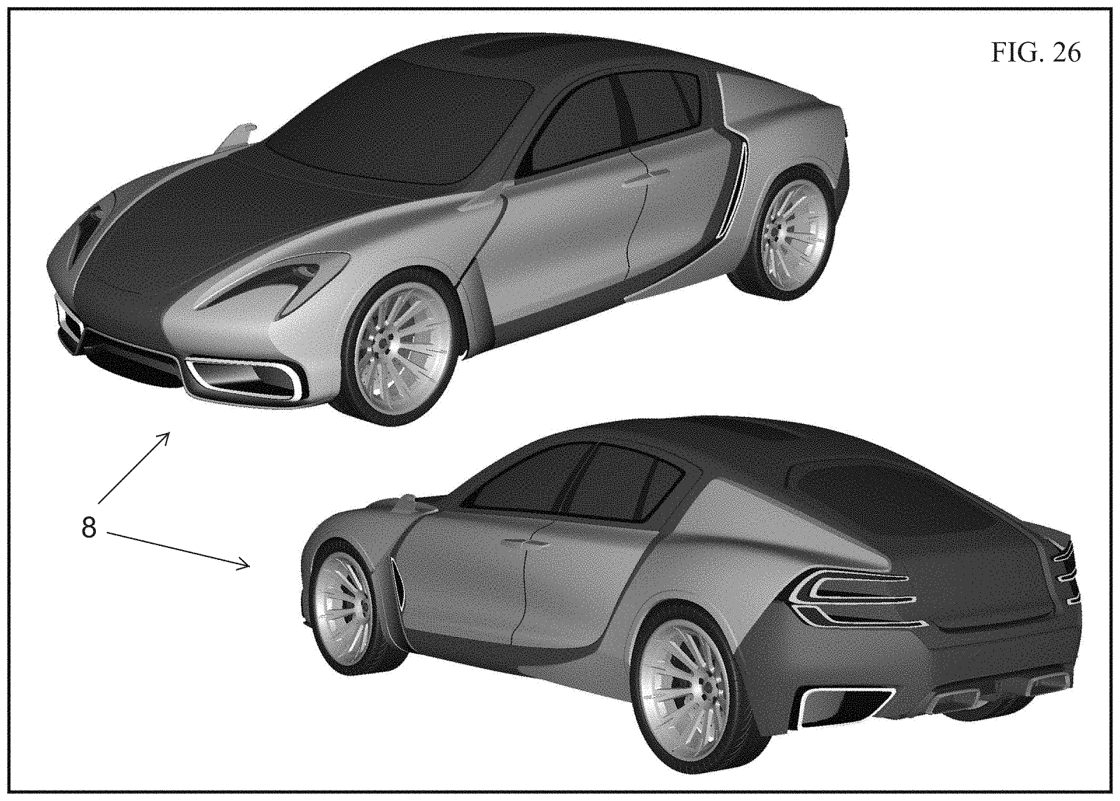

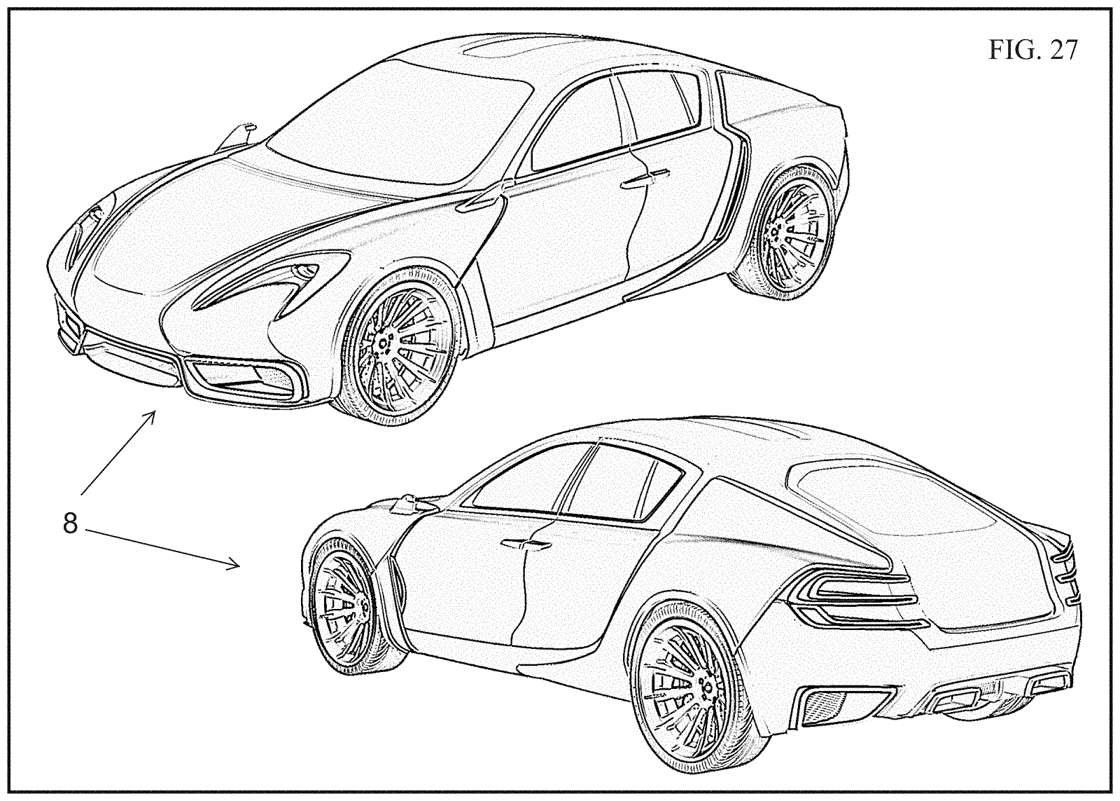

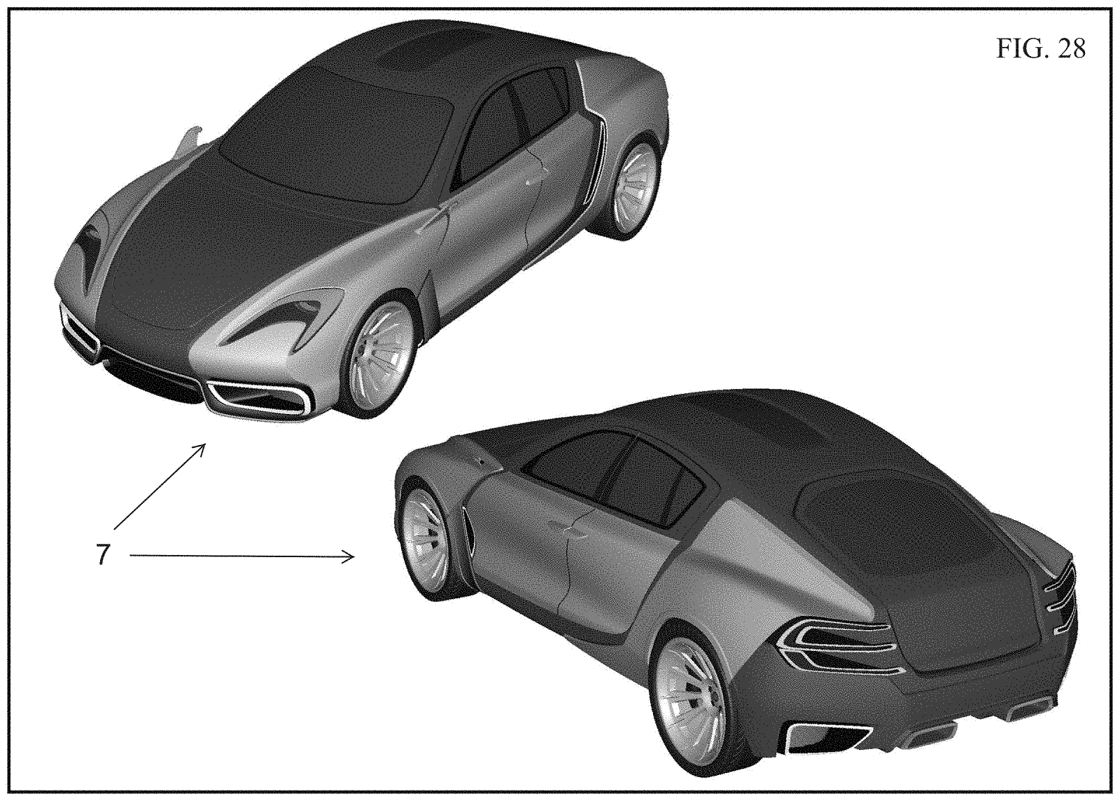

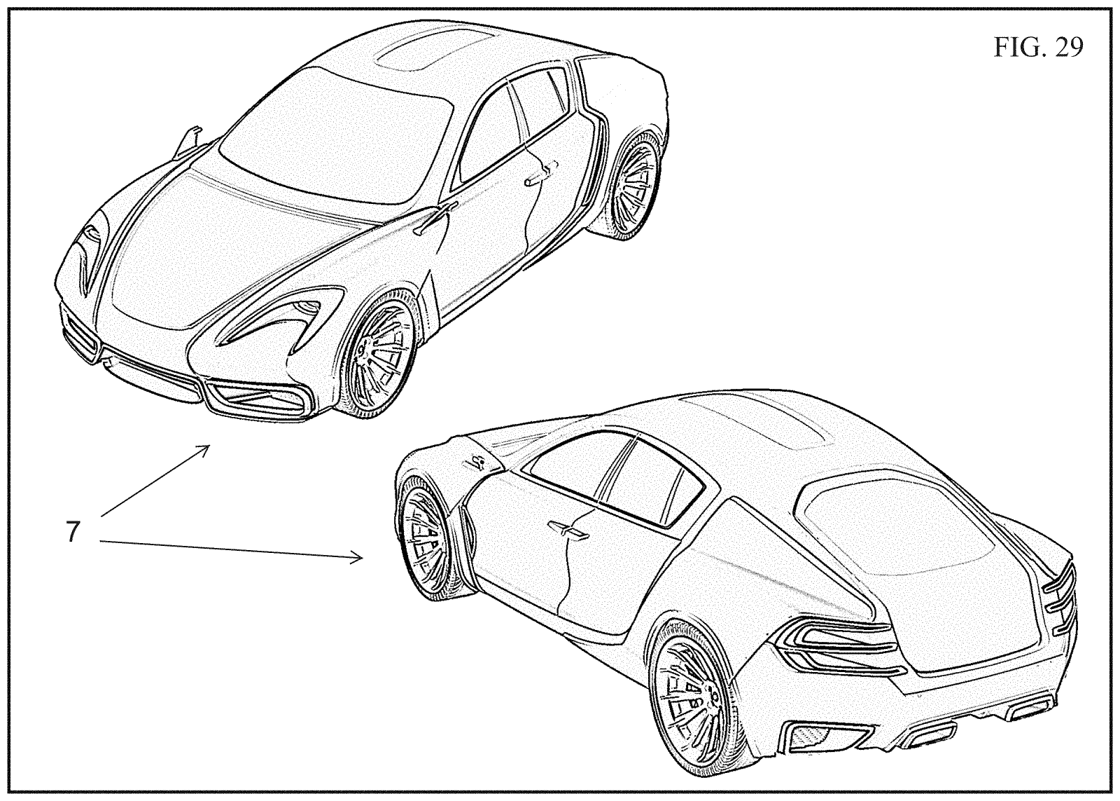

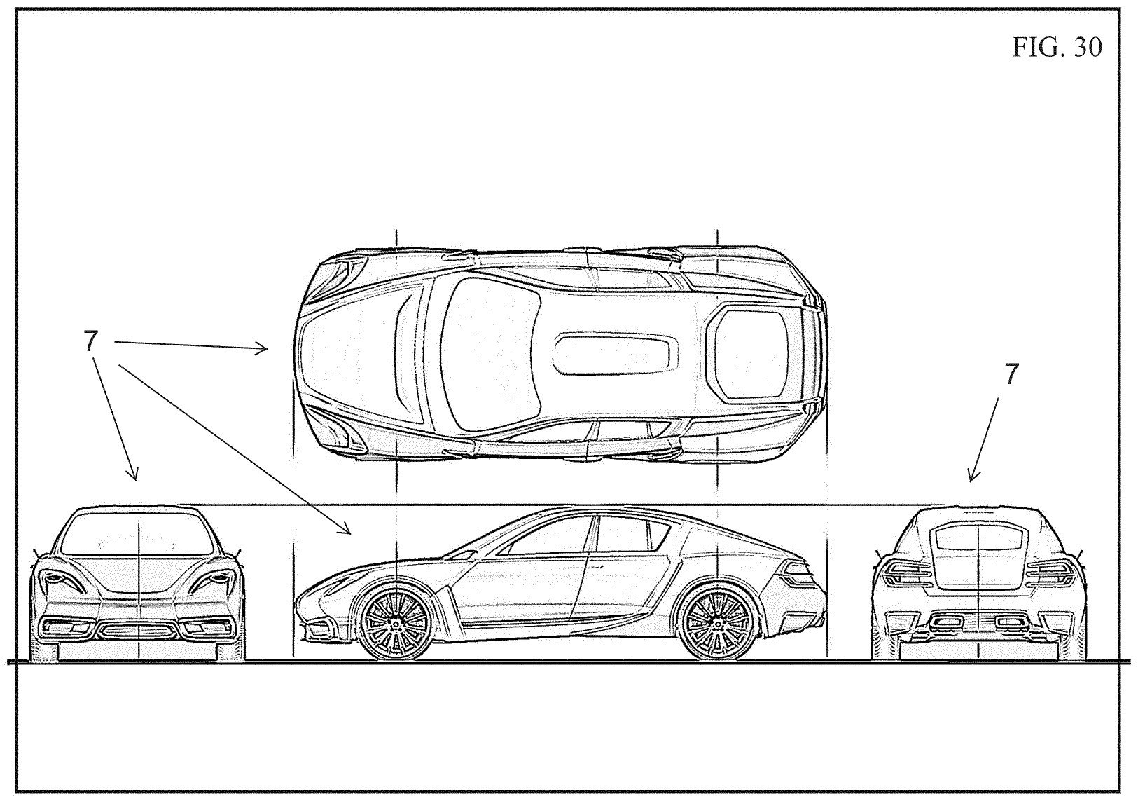

In a preferred embodiment of the present invention, the vehicle construction is unique in that the Cabin Module 1 and Drive Module Chassis 2 are preferably assembled as separate bodies prior to the vehicle marriage, or joining of the two. In a preferred embodiment of the present invention, the two modules are preferably connected via a set of 4-12, preferably 8, (dependent on weight class) connection points using high strength locking hardware 7.1, from micro car to heavy duty truck. Once assembled, the Joined Cabin Module Monocoque and Drive Module Chassis 7 retains and surpasses the safety, rigidity, flex and NVH (Noise, Vibration, Harshness) levels of a modern performance vehicle 8, as seen in FIGS. 22, 23, 26 and 27.

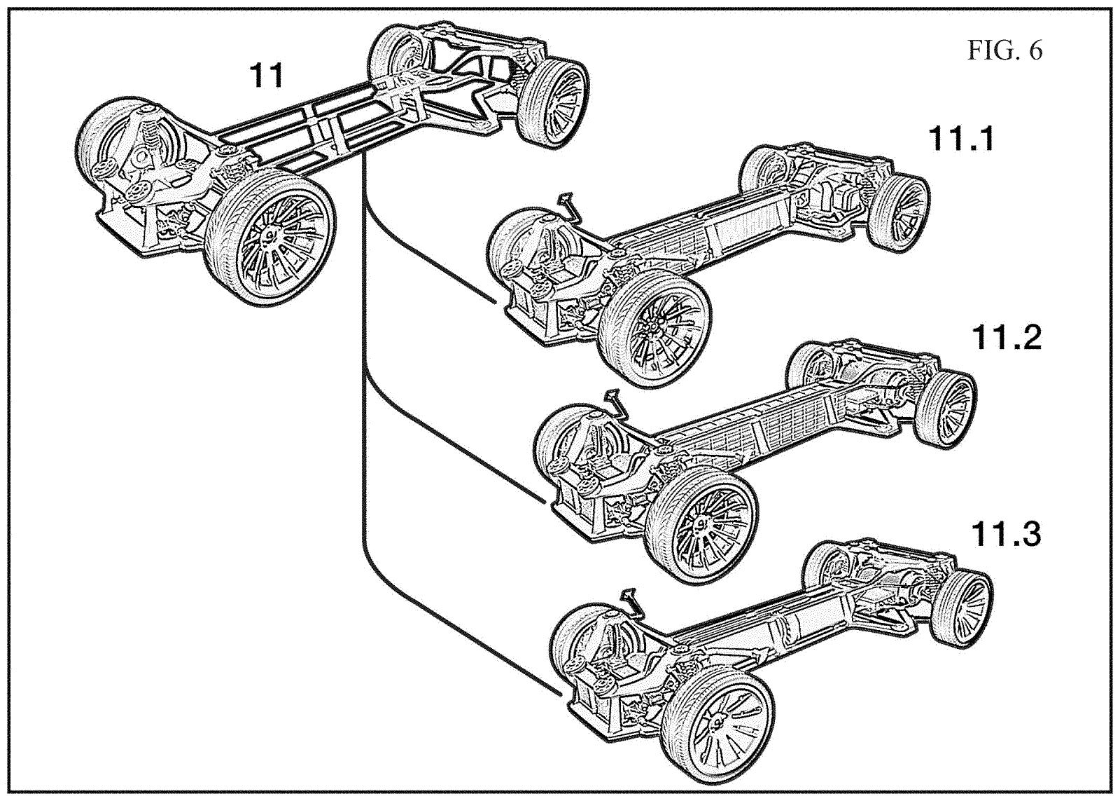

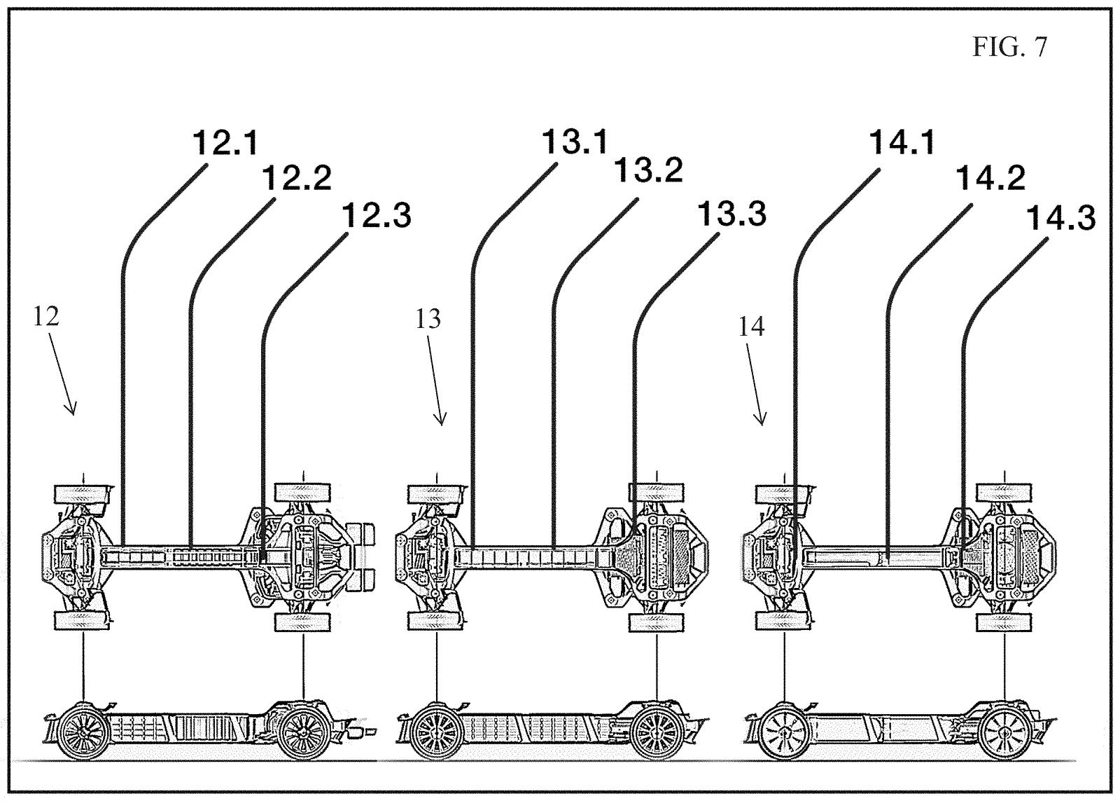

In a preferred embodiment of the present invention, the Drive Module Chassis 2 preferably allows for utilization of a variety of different drive train systems 11 as shown in FIG. 6. The Drive Module Chassis 2 can also be licensed to third party development teams to implement and test advanced drive train and fuel systems 11. Examples of three alternate configurations of the Drive Module 2, as seen in FIG. 6, are 1) Hybrid Gas/Electric 11.1, 2) Full Electric 11.2, and 3) Hydrogen Fuel Cell 11.3. In contrast to the flat-floor, electric skateboard package design most commonly used in full electric vehicles, the design of this invention is unique in that it is arranged and shaped in a manner which can hold either liquid, gas, or battery forms of fuel, all of which take up different volume areas in the platform. Accommodating for various shaped fuel cells allows the same platform to utilize multiple drive types.

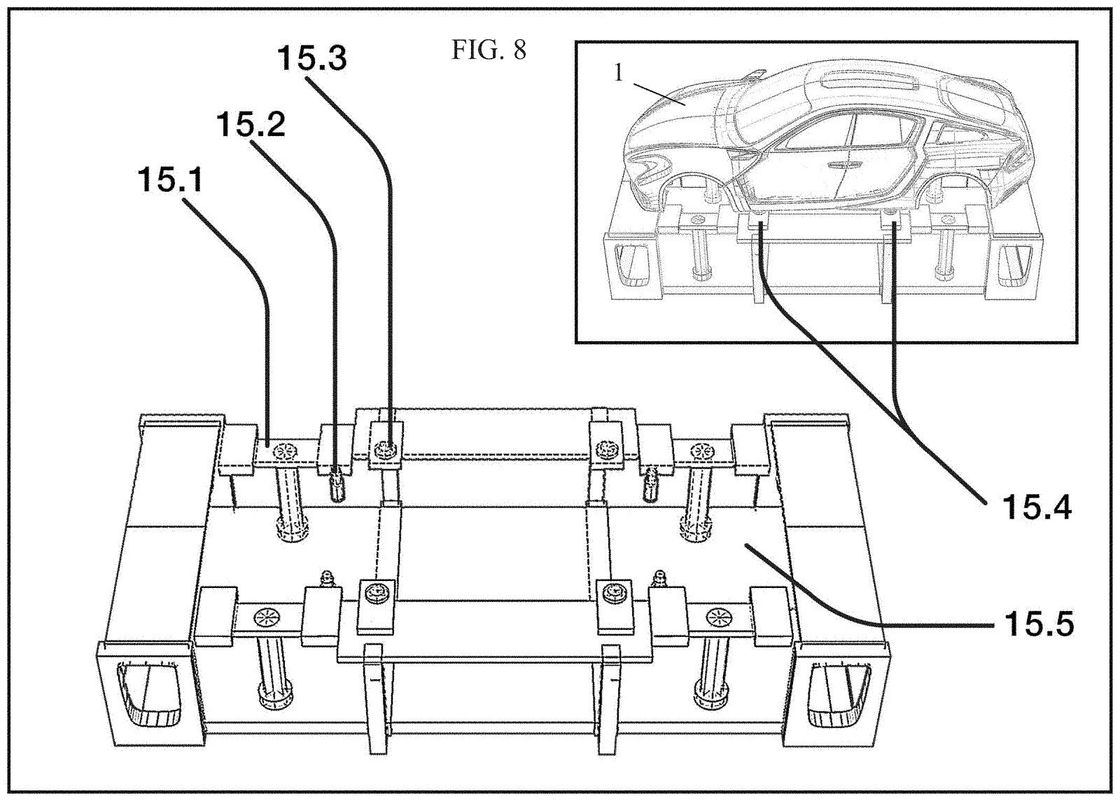

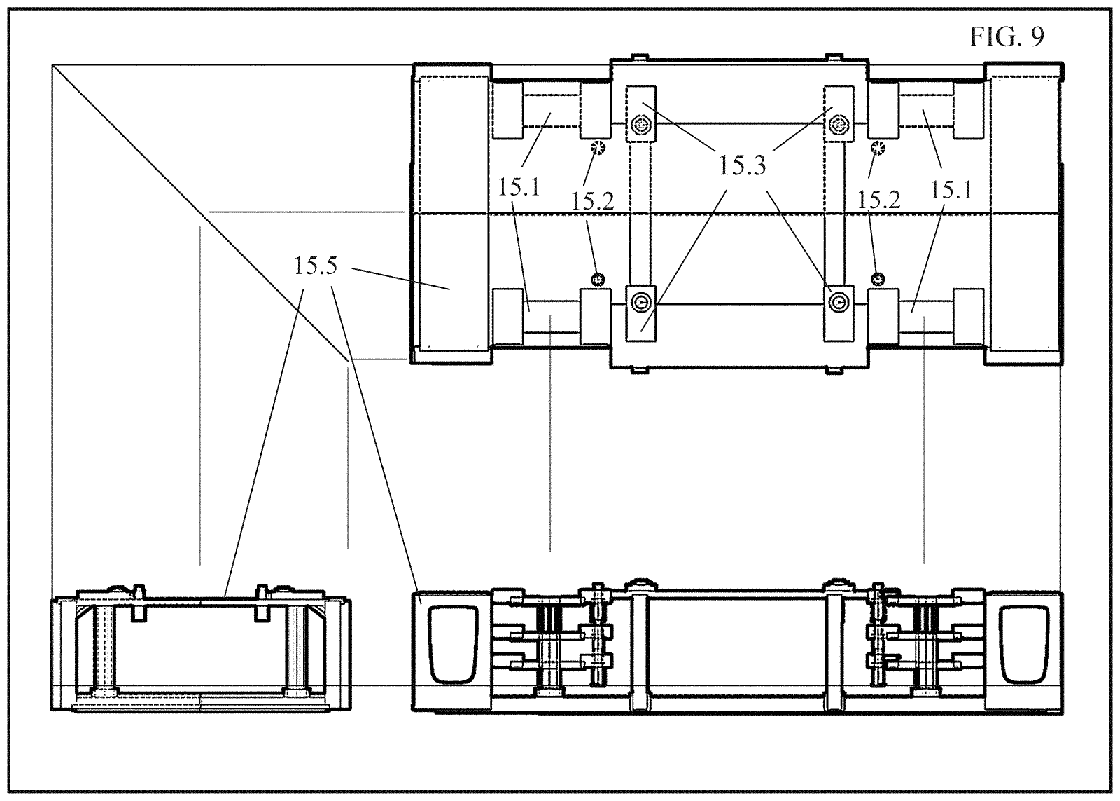

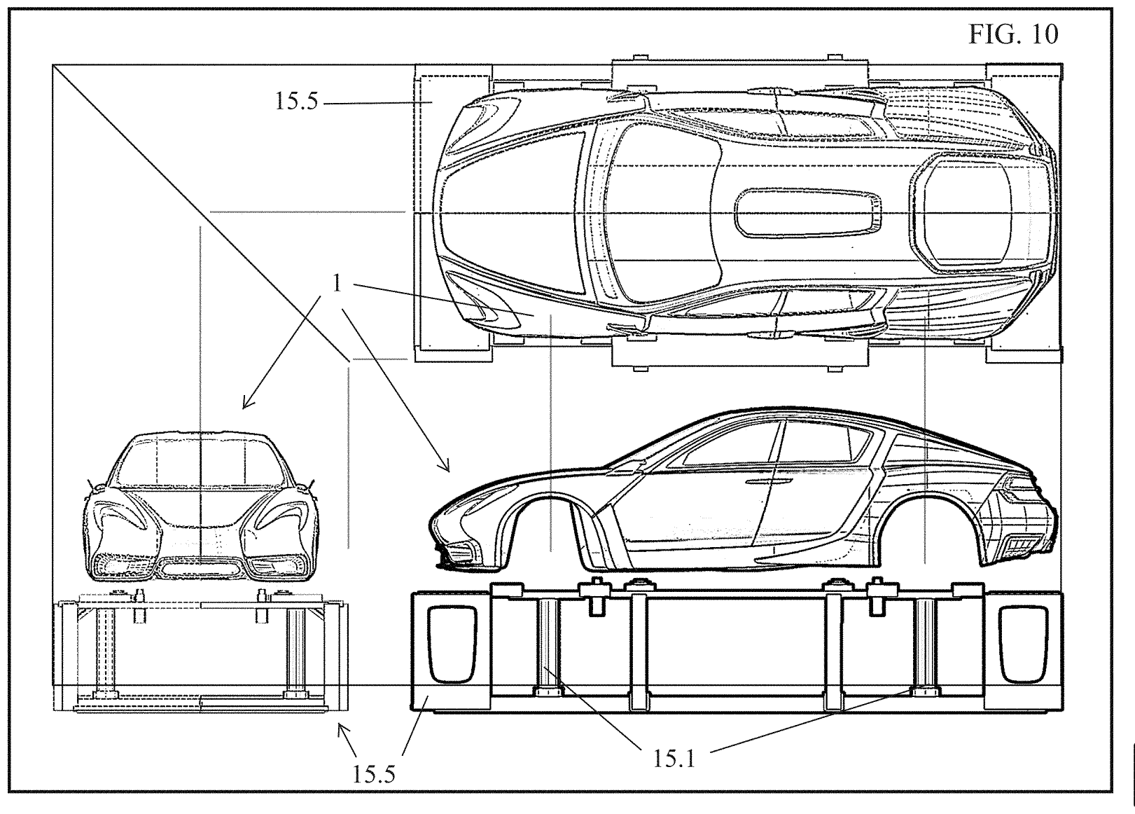

The present invention allows for swapping out Drive Modules 2 from the Cabin Module 1, similar in operation to a traditional hydraulic car lift system, as seen in U.S. Pat. No. 2,251,293, yet differing in layout and with the addition of several key components. In a preferred embodiment of the present invention, a modulator 15.5, as shown in FIGS. 8-21, is a key component of the swapping out process. Preferably, the modulator is sized and shaped to hold the Drive Module 2 and Cabin Module 1. In a preferred embodiment, during the swapping out process, the wheel supports 15.1 are preferably held in position by four hydraulic beams and sit parallel to the rest of the loading track. Electric Drills 15.3 are preferably incorporated in the wheel support assembly, and the drills 15.3 are preferably used to unscrew the assembly hardware 7.1 which holds the Drive Module 2 to the Cabin Module 1. Discs 15.2 preferably support the Cabin Module 1 once the Drive Module 2 has been dropped below, and in a preferred embodiment of the present invention, there are preferably four discs 15.2 that are preferably made of rubber. The gap in the modulator 15.4 (which is preferably an “I’ shaped gap), preferably allows the Drive Module 2 to drop below the Cabin Module 1, while leaving support beams for the Cabin Module 1.

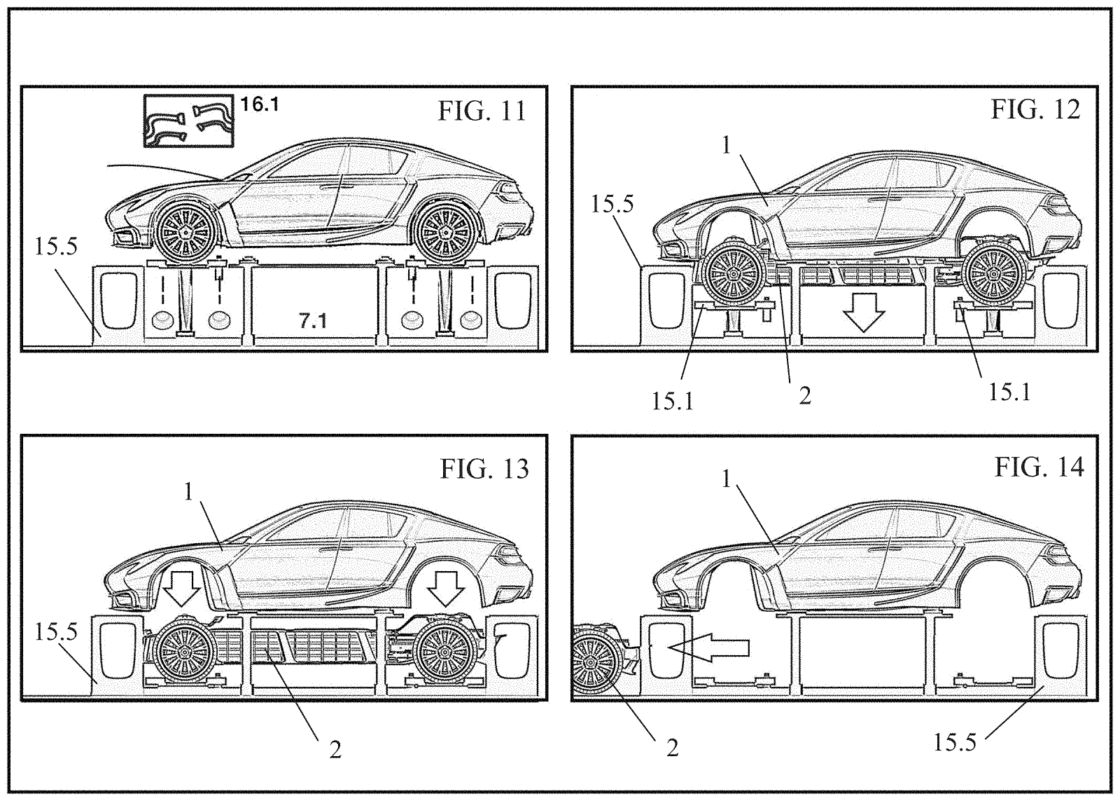

The present invention also allows for the Drive Module 2 to be separated from the Cabin Module 1 located on the modulator rig 15.5 as shown in FIGS. 11-14 and 19-21. While the vehicle is parked in place, the drill system 15.3 preferably unscrews the assembly hardware 7.1 from beneath the vehicle as shown in FIG. 11 to separate the Drive Module 2 from the Cabin Module 1. At the same time, a technician preferably decouples the Connecting Ports 16.1 from underneath the hood. With the Drive Module Hardware 7.1 unfastened and the connecting ports decoupled 16.1, the Drive Module 2 is preferably lowered from the Cabin Module 1 preferably via the wheel supports 15.1 as shown in FIG. 12. In a preferred embodiment, the wheel supports 15.1 are preferably hydraulic. With the Drive Module 2 completely lowered, the Cabin Module 1 preferably rests atop the support discs 15.2 as shown in FIG. 13. The Drive Module 2 is then preferably connected to a control device preferably operated by a technician and preferably driven off of the modulator rig autonomously as shown in FIG. 14.

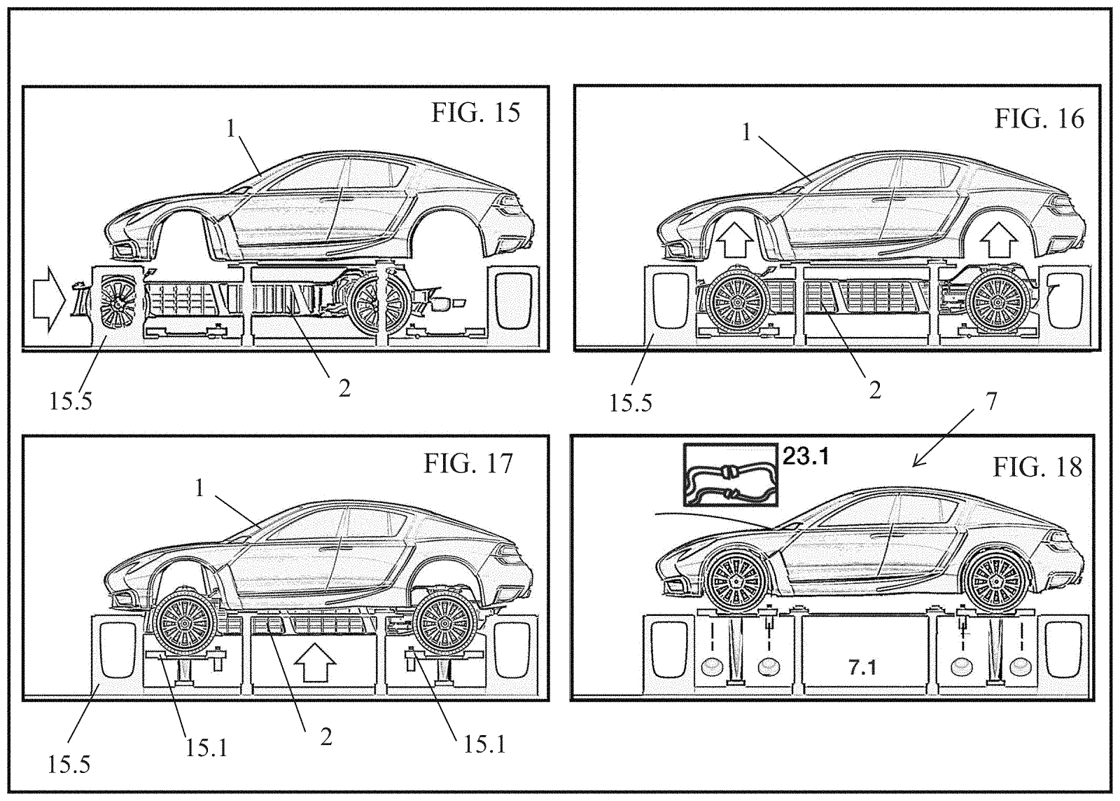

The present invention also preferably has a mechanism to reinstall the separate Drive Module 2 to the Cabin Module 1 as shown in FIGS. 15-18. In a preferred embodiment, a separate Drive Module 2 is driven onto the modulator rig 15.5 by a technician as shown in FIG. 15. In a preferred embodiment, the Drive Module 2 is preferably aligned with the Cabin Module 1 and raised preferably via the wheel supports 15.1 as shown in FIG. 16. In a preferred embodiment, the wheel supports 15.1 are preferably hydraulic ones. The Drive Module 2 is preferably raised into place within the Cabin Module 1, and both modules are preferably lifted together off of the support discs 15.2. In a preferred embodiment as shown in FIG. 18, the drills 15.3 (preferably pneumatic ones) screw the assembly hardware 7.1 back into place securing the two modules together, while concurrently the system connecting ports are re-attached 23.1.

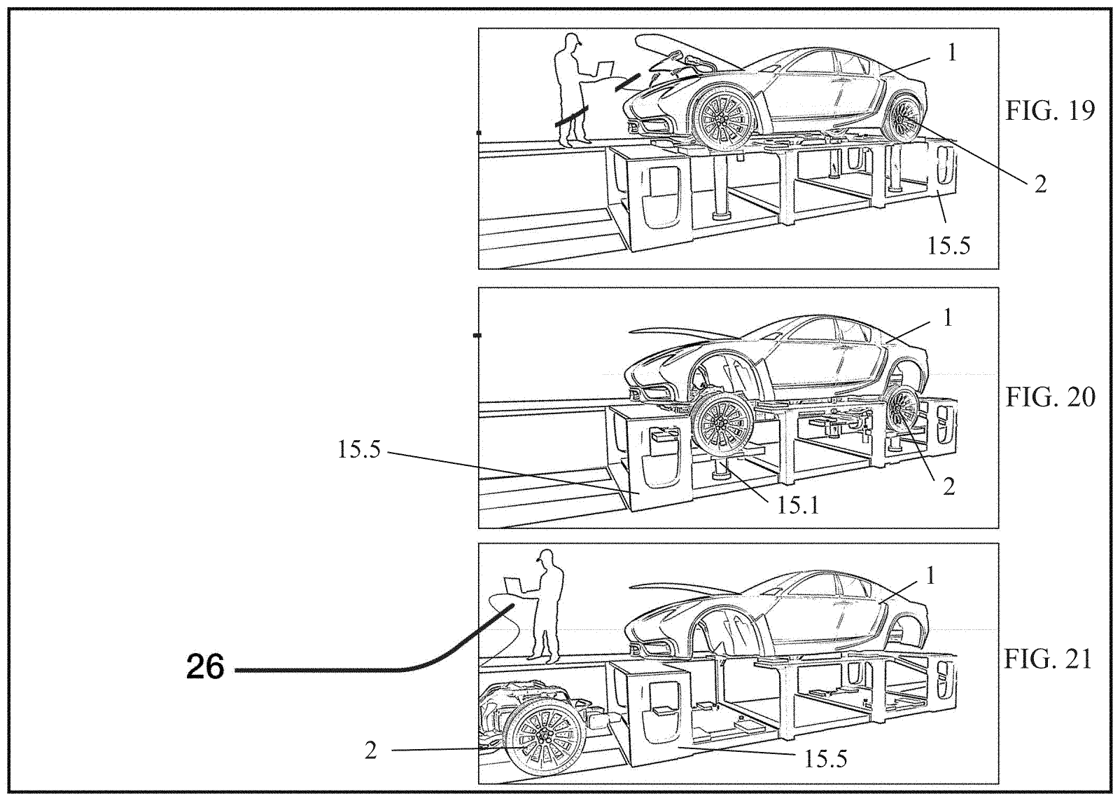

In a preferred embodiment, with all safety protocols in place and followed properly, the entire module swap process should preferably take under 90 seconds. The technician preferably manages the connecting ports while the vehicle preferably sits atop the modulator rig 15.5, and a systems check is done to coordinate communication between the main ports as shown in FIG. 19. The modulator 15.5 preferably drops the Drive Module 2 from under the Cabin Module 1 as shown in FIG. 20. The technician is preferably able to control the Drive Module 2 via a licensed application on a laptop 26 as shown in FIG. 21. Ultimately, the action of decoupling and swapping drive modules will preferably have autonomous capability, although the process order will remain the same.

### PARTS LIST

The following is a list of parts and materials suitable for use in the present invention:

Parts Number Description
1 Cabin Module
2 Drive Module Chassis
3 Secured Primary Drive CAN bus
4 Power Supply Converter
5.1 Umbilical Connector Port
5.2 Power Connector Port
6 External Charging/Refueling Ports
7 Joined Cabin Module Monocoque and Drive Module Chassis
7.1 Locking Hardware/Assembly Hardware
8 Modern Performance Vehicle
11 Advanced Drive Train and Fuel Systems
11.1 Gas/Electric Hybrid
11.2 Full Electric
11.3 Hydrogen Fuel Cell
12 Hybrid Gas/Electric
12.1 Battery Cells
12.2 Gasoline Tank
12.3 Combustion Motor/Transmission
13 Full Electric
13.1 Battery Cells
13.2 Electric Converters
13.3 Electric Motors
14 Hydrogen Fuel Cell
14.1 Hydrogen Tanks
14.2 Fuel Cells
14.3 Electric Motors
15.1 Wheel Supports
15.2 Support discs
15.3 Drill System
15.4 Gap in the modulator
15.5 Modulator
16.1 Decoupling of Connecting Ports
23.1 Attachment of connecting ports
26 Licensed Communication Remote

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A modular vehicle system comprising:
a) a preassembled body, comprised of a Primary System Network and a Secondary System Network that can operate independently of each other, wherein the Primary System Network manages the driving interface, main controls, and power supply of the vehicle, and wherein the Secondary System Network;
b) a preassembled chassis that connects to and can mate with the preassembled body via locking hardware; and
c) a simplified network that allows for communication between and integration of the preassembled body and the preassembled chassis to form and operate as a single vehicle.

2. The vehicle system of claim 1, wherein the Primary System Network is comprised of and is the power management for Info and Media, Heating Venting and Cooling, Auxiliary, Amenities, and Safety of the vehicle.

3. The vehicle system of claim 2, wherein the Primary System Network is channeled through a Secured Primary Drive BUS.

4. The vehicle system of claim 1, wherein the Secondary System Network, wherein the Secondary System Network has at least one battery for backup for power.

5. The vehicle system of claim 3, wherein the BUS connects to the preassembled chassis via a main umbilical connector port.

6. The vehicle system of claim 1, wherein the power supply of the preassembled body connects to the preassembled chassis via a power connector port.

7. The vehicle system of claim 1, wherein the preassembled chassis is one of the following:
a) hybrid gas/electric;
b) full electric; or
c) hydrogen fuel cell.

8. The system of claim 7, wherein the hybrid gas/electric preassembled chassis is comprised of at least one battery cell, a gasoline tank, and a combustion motor/transmission.

9. The system of claim 7, wherein the full electric preassembled chassis is comprised of at least one battery cell, at least one electric converter, and at least one electric motor.

10. The system of claim 7, wherein the hydrogen fuel cell preassembled chassis is comprised of at least one hydrogen tank, at least one fuel cell, and at least one electric motor.

11. A method of assembly of a modular vehicle system comprising:
a) providing a modulator rig, comprised of wheel supports, support discs, and a drill system;
b) placing a preassembled body atop the modulator on the support discs;
c) introducing a preassembled chassis within the perimeter of the modulator rig and placing the wheels of the chassis within the wheel supports, aligning the chassis with the preassembled body, and raising the chassis via the wheel supports up to the body, lifting the body off the support discs;
d) connecting the chassis to the body via a drill system, securing the chassis to the body, and connecting a communication network between the body and the chassis so that they can operate as a singular vehicle.

12. The method of claim 11, wherein the drill system is a pneumatic drill system.

13. The method of claim 11, wherein the wheel supports are hydraulic.

14. A method of uncoupling a modular vehicle system comprising:
a) providing a modulator rig, comprised of wheel supports, support discs, and a drill system;
b) placing a preassembled body, connected to a preassembled chassis via assembly hardware and connecting ports, atop the modulator rig;
c) using the drill system to unscrew the assembly hardware;
d) decoupling the connecting ports;
e) lowering the chassis from the body via the wheel supports while allowing the body to remain on the support discs;
f) connecting the chassis to a control device; and
g) removing the chassis off the modulator rig.

15. The method of claim 15, wherein the wheel supports are hydraulic.

16. The method of claim 15, wherein the drill system is a pneumatic drill system.

17. (canceled)
